(19) United States
(12) Patent Application Publication
(10) Pub. No.: US 2014/0074701 A1
(43) Pub. Date: Mar. 13, 2014

(54) PHYSICAL-VIRTUAL GIFTING VIA ONLINE BILLPAY

(71) Applicants: Tamara S. Kingston, Peoria, AZ (US); Charles J. Burrell, Middleburg, FL (US); Lisa M. Martin, Slingerlands, NY (US)

(72) Inventors: Tamara S. Kingston, Peoria, AZ (US); Charles J. Burrell, Middleburg, FL (US); Lisa M. Martin, Slingerlands, NY (US)

(73) Assignee: Bank of America Corporation, Charlotte, NC (US)

(21) Appl. No.: 13/614,740

(22) Filed: Sep. 13, 2012

(51) Int. Cl. G06Q 20/14; G06Q 20/22

(52) U.S. Cl. 705/40; 705/39

(57) ABSTRACT

Apparatus and methods for improving online billpay are provided. In some embodiments, the apparatus and methods may receive an attachment from a donor. The attachment may be submitted by the donor for inclusion in a gratuitous transfer of funds to a beneficiary. The transfer of funds may be tagged using an electronic marker. The tag may include a set of predefined parameters. The tag may restrict the use of funds according to a set of predefined parameters. The gratuitous transfer of funds may be electronically transmitted. The transfer may be confirmed by an electronic notification.

### FIELD OF TECHNOLOGY

Aspects of the disclosure relate to gift giving.

### BACKGROUND

Alternative methods of gift giving have become desirable. Online gifting has become a common capability. Typically, an internet website platform is used to facilitate giving a gift.

Gift giving may be effected by physical mail, in-person, paper or electronic check, electronic fund transfer, third party payment network such as the Automated Clearinghouse (“ACH”), general ledger transfer in a closed-loop payments network such as PayPal®, of San Jose, Calif., or through other electronic means for effecting fund transfer between parties.

For example, a party may purchase a gift on the website of Bed Bath & Beyond®, of Union, N.J., for a friend using an electronic payment. Gift givers (“giftors”) may include consumers, businesses or others. Gift giving may encompass a monetary gift, a physical item, such as an article of clothing or a toy, sentimental gifts and other suitable gifts.

When a giftor purchases a gift on an electronic website, in-person, or by mail, the giftor may include an attachment, such as a note or message, a branded store-value card or a physical greeting card, such as a Hallmark® greeting card from Hallmark Cards, Inc. of Kansas City, Mo.

Another aspect of internet usage is directed to online bill payment. Online bill payment (“billpay”) has become a common capability in banks and other financial institutions that offer e-commerce websites. Typically, an internet website platform is used to facilitate payment, by a payor to a payee, of bills and debts. Payors and payees may include consumers, small business customers and others. Billpay may encompass payment of bills, debts and other monetary transactions.

It would be desirable to provide apparatus and methods for combining gift giving and online billpay to leverage online billpay mechanisms in order to facilitate giving a gift to another party.

### SUMMARY OF THE INVENTION

It is an object of this invention to provide apparatus and methods for giving a gift.

The apparatus and methods may involve receiving an electronic request from a donor requesting that funds be transferred to a beneficiary. The transfer may comprise a gift. The apparatus and methods may involve receiving an attachment from the donor. The attachment may be submitted by the donor for inclusion in a transaction. The attachment may comprise characteristics. The characteristics may be stored in a searchable database. The gift may be transferred by electronic transfer. The electronic transfer may leverage online billpay systems and methods to give the gift.

Some embodiments of the invention may involve transmitting a payment opportunity. The payment opportunity may be a gift opportunity. The opportunity may be transmitted from a beneficiary to a donor. The beneficiary may be a donee, payee or creditor. The opportunity may be used to benefit a donee. The opportunity may be transmitted by an electronic communication. The electronic communication may be transmitted to the donor. The donor may make an electronic request that funds be transferred. The funds may comprise a gift. Apparatus and methods of the invention may include receiving an attachment from the donor. The donor may submit the attachment for inclusion in a transaction.

Apparatus and methods of the invention may include tagging the funds to be transferred. The tag may be comprised of an electronic marker. The use of the funds may be restricted. The restriction may include an earmark of the funds for certain uses. The donor may instruct an intermediary to restrict use of the funds. The restriction may apply to a beneficiary. The beneficiary may be required to use the funds according to predefined parameters. The predefined parameters may be specified by the donor. The predefined parameters may be specified by an intermediary.

Apparatus and methods for electronically attaching information to a transaction between a donor and a beneficiary are provided. The apparatus and methods may involve receiving an electronic request from the donor. The request may be a request to transmit funds to the beneficiary. The donor may attach a data object to an electronic record associated with the transaction. The record identifier may be any suitable data, such as a transaction identification number, a data record serial number, a payor identifier and a payee identifier. The data object may include information that the donor selects. The information may relate to the transaction, terms of the transaction, prior communications between the donor and the beneficiary, prior communications among the donor, the beneficiary and a third party or any other suitable communication or event. The data object may be an electronic file, an electronic folder, or any other suitable data structure. The data object may be a branded store-value card. The data object may be a greeting card. The data object may be formatted as an image, text, audio, video or any other suitable format. The apparatus and methods may include establishing an electronic link between the data object and the beneficiary.

Some embodiments of the invention may involve providing access to gift giving information that corresponds to a transaction between a donor and a beneficiary. The apparatus and methods may involve receiving a data object that the donor has selected for inclusion in the transaction. The data object may be stored in a database. A pointer may be provided. The pointer may point from a stored record of the transaction to the data object. A request for the gift giving information may be received from the donor. In response to the request, the gift giving information may be provided to the donor. Once provided, notification may be sent to the beneficiary indicating that the gift giving information has been provided to the donor, as a confirmation of receipt.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 is a schematic diagram of apparatus that may be used in accordance with the principles of the invention;

FIG. 2 is a flow diagram that shows a process in accordance with the principles of the invention;

FIG. 3 is a flow diagram that shows another process in accordance with the principles of the invention;

FIG. 4 is a flow diagram that shows a process that corresponds to a portion of the process shown in FIG. 3;

FIG. 5 is a flow diagram that shows another process that corresponds to a portion of the process shown in FIG. 2-4;

FIG. 6 shows a graphical display that may be generated and displayed in accordance with the systems and methods of the invention;

FIG. 7 shows another graphical display that may be generated and displayed in accordance with the systems and methods of the invention; and

FIG. 8 shows yet another graphical display that may be generated and displayed in accordance with the systems and methods of the invention.

### DETAILED DESCRIPTION OF THE INVENTION

Apparatus and methods for improving gift giving processes are provided. Gift giving typically involves a giving party (“donor” or “giftor”) and a recipient and/or beneficiary. A gift may be given using online bill payment systems and methods. Conventional online bill payment typically involves a paying party (“payor” or “donor”), an intermediary (such as a bank, a billpay service or a billpay network) and a recipient and/or beneficiary.

The gift giving may involve the transfer of funds as a gift. The gift funds may be transferred leveraging systems and methods of online billpay. The gift may be money. The gift may be a physical item of monetary value. The gift may be a virtual item of monetary value, such as a branded store-value card, credit, virtual token, or virtual cash. The gift may be earmarked as a payment on a debt. The gift may be an unsolicited gift without a stated purpose.

A gift may be transferred using peer-to-peer systems. Peer-to-peer transfers may involve peer-to-peer banking. The gift funds may be transferred directly from one individual to another. The gifts may bypass an intermediary.

A gift may be transferred by ACH transfer or any other suitable electronic transfer. A gift may be transferred pay electronic check, paper check, or any other suitable paper transfer. A gift may be transferred by a credit card transaction. A gift may be transferred by a debit card transaction. A gift may be transferred by a wire transfer.

A donor may request that an intermediary, such as a bank or financial institution, transfer funds to a beneficiary. The donor may be a client or customer of the intermediary. The donor may request the transfer by electronic communication. The intermediary may transfer funds directly to the beneficiary.

The funds may be intended as a gift to the beneficiary. The gift to be transferred may originate from an account of the donor. The gift to be transferred may originate as a donor deposit. The donor may deposit funds to an intermediary account.

The intermediary may transfer funds to the beneficiary's financial account. The intermediary may transfer funds via a virtual store-branded value card.

The beneficiary may be a donee. The donor may intend for the gift to benefit the donee. The beneficiary may be a creditor. The beneficiary may be a payee. The beneficiary may be a future holder of the donee's debt.

The donor may be notified by another party of a payment opportunity. The payment opportunity may be for the benefit of another party. The payment opportunity may be an existing debt. The payment opportunity may be a charitable donation. The payment opportunity may be a future obligation. The donor may request to be notified of payment opportunities.

The donor may be notified of the opportunity by an intermediary. The intermediary may be contacted by a potential beneficiary. The potential beneficiary may request that the intermediary contact the donor. The intermediary may offer the opportunity based upon its own preferences.

The donor may be one individual. The donor may be a group of donors. The group of donors may join together to give one gift. The group of donors may each send an individual branded store-value card. The group of donors may each send an individual greeting card. The greeting card may be the gift.

The branded store-value card may be suitable for use only to purchase from a certain brand. The branded store-value card may be configured to be used for all suitable purchases. All suitable purchases may include purchases from all brands. For example, a father may give his son a branded store-value card with a value of $25. In a further example, the branded store-value card may be branded as a Superstore X card.

The greeting card may be a card accompanying a gift. The greeting card may be a card with a message. The message may describe the gift being given. The greeting card may contain a multimedia component, such as audio or video. The greeting card may be an electronic greeting card. The greeting card may be a physical greeting card. For example, a grandmother may give her granddaughter a check for $50. In a further example, the check may be accompanied by a greeting card. In yet a further example, the greeting card may contain a written message stating “Happy Birthday” and an audio recording of the grandmother saying “Happy Birthday.”

The branded store-value card may be a shared card. The greeting card may be a shared card. The branded store-value card and/or greeting card may be shared by all the donors. The shared card may be electronically sent from one donor to another donor. The shared card may be configured to include a text box. The text box may be one shared text box. The shared card may be configured to have multiple text boxes. Each donor may have a text box unique to that donor.

The shared greeting card may be attached to a gift transfer. The shared greeting card may be sent separately from a gift transfer. The shared greeting card may be sent electronically. The shared greeting card may be sent as a physical copy.

The beneficiary may request that an intermediary notify the donor of an outstanding debt. The beneficiary may notify the donor directly. The intermediary may notify the donor via an electronic communication. The notification may include an attachment. The attachment may be a bill, record of a debt, or any other suitable attachment.

The electronic communication may include information provided by the beneficiary or intermediary. The provided information may include: payee account information, beneficiary account information, beneficiary or payee account numbers, payee address, balance due on the debt and due date of the debt.

The intermediary may offer the opportunity based upon a low account balance of a potential beneficiary. The intermediary may offer the opportunity based on previous action by the donor. Previous action may include past gifts by the donor. Past gifts may include past gift fund transfers. Past gifts may include gifts to the potential beneficiary.

Previous action may include a prior request by the donor to be notified based on predetermined account activity. The account activity may be the account activity of another party. Predetermined account activity may include a threshold account balance. Predetermined account activity may include a certain number of outstanding payment obligations or bills.

The donor may be notified of the payment opportunity by a payee. The payee may request that the intermediary send a notification to the donor. The payee may have a subscription or account with the intermediary.

The account may be configured to display a list of potential donors. The list may be a list of individuals submitted by the beneficiary. The list may be provided by the intermediary.

The individuals may be contacted for giving opportunities. The individuals may be aware that they are listed as potential donors. The individuals may be unaware that they are listed as potential donors.

The potential donor may be contacted by a payee. The payee may contact the donor as a result of the beneficiary's financial difficulties. The payee may contact the donor as a result of the beneficiary's request to do so. The payee may contact the donor on its own volition. The potential donor may be contacted by the beneficiary. The potential donor may be contacted by an intermediary.

For example, a customer of Electric Company may give the name and contact information of his uncle as a potential donor. The uncle may be unaware of this exchange. Electric Company may notify the uncle of a giving opportunity. In a further example, the nephew may request that Electric Company notify the uncle of a giving opportunity.

A giving opportunity may be offered in the form of a registry. The registry may be a gift registry. The gift registry may be an electronic gift registry. The gift registry may be configured to allow a beneficiary to request a gift and/or a number of gifts. The registry may be hosted by an intermediary. The registry may be hosted by the beneficiary. The registry may be hosted by a third-party website and/or entity.

The gift may be a request for money. The beneficiary may electronically transfer funds via the registry. The registry may be configured to offer payment opportunities. The beneficiary may register bills and invoices on the registry. The beneficiary may invite donors and/or potential donors to view the registry. The registry may be publicly searchable. The registry may be private. Viewing the registry may be offered by invitation only.

A donor may choose a bill from the registry. The donor may pay that bill. A notification may be sent to the beneficiary that a donor has paid a bill. The registry may be configured to send a notification of a payment opportunity. The notification may be sent to a potential donor.

The registry may be created for a specific event. The registry may be associated with an alias. For the purposes of this application, the alias may be an identifier. The alias may be an identifier of the beneficiary. The alias may be a telephone number, email address, username, birthdate, a unique phrase or any other suitable alias.

The alias may allow for a gift payment to be made. The gift payment may be made without providing secure information.

The alias may be provided by a donor. The donor may provide the alias as a registry identifier. The alias may be provided in place of the beneficiary's account information.

The account may be configured to send notifications to a donor or potential donor. The notifications may include potential giving opportunities. The notifications may be configured to display opportunities of relevance to the donor. Relevance may be determined from information provided by the donor, information provided by the beneficiary, account information of the beneficiary, account information of the donor, public information, information from a payee, or any other suitable source.

The notifications may include the name of the potential beneficiary. The notifications may include the amount due.

The payee may offer a payment plan to the donor. The payment plan may be a customized plan. The payment plan may allow for monitoring the beneficiary's use of gift funds. The payment plan may allow for gifts to allow the beneficiary to pay certain obligations. The obligations may be specified by the donor.

The gift may be transferred to a third party. The third party may be a creditor of the donee. The third party may be a payee. The payee may provide a service to the donee. The payee may provide something of value. The third party may be a gratuitous beneficiary.

The donor may transfer the gift directly to the beneficiary. The donor may transfer the gift directly to the account of the beneficiary. The donor may transfer the gift to the payee in the name of the beneficiary.

The donor may instruct an intermediary to transfer the gift payment. The donor may instruct the intermediary to transfer the gift at a predetermined time. The donor may instruct the intermediary to transfer the gift on a recurring basis.

The donor may instruct the intermediary to transfer the gift upon the occurrence of a specified event. A specified event may include a triggering event affecting the beneficiary. The triggering event may be include a certain account balance in the beneficiary's account. The account balance triggering the transfer may be predetermined by the donor. The triggering event may initiate an automatic transfer. For example, the donor may instruct the bank to transfer a payment to the utility company for the payment of an outstanding bill.

In a further example, the donor may instruct the bank to transfer the payment when the beneficiary's account balance falls below $2000, or some other suitable balance. In another example, the donor may instruct the bank to transfer a gift to a friend or relative as a present upon the occurrence of a milestone, such as a birthday or graduation.

The account may be configured to allow a donor to directly transmit a gift payment to payee. The gift payment may be transmitted from the donor's account. The intermediary may notify the beneficiary of the payment.

For example, a father may transmit a payment to Water Company for the payment of his daughter's water bill. The intermediary may send a notification to the daughter that her water bill has been paid. In an alternative example, Water Company may notify the daughter that her water bill has been paid. In yet another example, the father may walk into a local branch of Bank C and request that the bank send a payment to Water Company for his daughter's water bill. The father may request that Bank C notify his daughter of the payment.

The gift transfer may be an electronic transfer. The electronic transfer may occur by any suitable method. The electronic transfer may be configured to send out a physical greeting card. The electronic transfer may be configured to send out a branded store-value card.

The gift transfer may be initiated by an electronic processor coupled with a memory. The gift transfer may continue by sending out a physical gift. The physical gift may be a paper check. The physical gift may be a physical branded store-value card. The physical gift may be a greeting card. The physical gift may be any sort of acceptable gift or present.

For example, a parent may initiate a gift transfer to his or her son. The gift may be transferred leveraging the systems and methods of online billpay to give the gift. The parent may select an option to send a paper check with the gift amount to their son. In a further example, the parent may choose to transfer funds electronically, and send a physical greeting card. In yet another example, the parent may use online billpay systems and methods to send a paper check and a stuffed animal, or other suitable gift, to their son.

An account may be configured to receive an instruction and/or set of instructions. The instruction may be to send a physical card. The physical card may be a greeting card. The physical card may be a branded store-value card. The physical card may be sent to a beneficiary. The beneficiary may receive an electronic payment and/or gift transfer in addition to the greeting card. The beneficiary may receive a paper payment and/or gift transfer in addition to the greeting card. The paper payment may be a paper check.

The transfer of funds may be completed electronically. The transfer of funds may be completed by using online billpay systems and methods to give the gift. Online billpay may be configured to send out a virtual card with the electronic funds transfer. The virtual card may be an e-card.

The gift payment may be a branded store-value card. The branded store-value card may be a physical card. The physical card may be delivered to the beneficiary. The branded store-value card may be a virtual card. The virtual card may be used to execute a payment. The virtual card may be sent as an attachment to the gift transfer. The virtual card may be sent separately via e-mail.

The gift transfer may be initiated on a webpage. The webpage may be configured to process a gift request. The gift request may include a request to transfer a gift payment. The gift request may include a request to send any suitable gift. The gift request may include a request to send a greeting card. The greeting card may accompany a gift and/or gift payment. The gift request may include a request to send a branded store-value card.

The virtual greeting card may contain a personalized message. The message may be transmitted as a separate attachment. For example, a parent may transfer a monetary gift to their child's account with a virtual greeting card.

The branded store-value card and/or greeting card may indicate the acceptable uses for the monetary gift. The branded store-value card may be earmarked for use only with certain payees.

Acceptable uses for branded store-value card cards may be specified by the donor. Acceptable uses for funds may be specified by the donor. The donor may instruct the intermediary to prevent unacceptable uses of funds. The intermediary may configure the account to recognize acceptable uses of the funds. The intermediary may configure the account to recognize unacceptable uses of the funds. The account may be configured to recognize unacceptable uses of funds. The account may be configured to take action when an unacceptable use is attempted.

Acceptable uses for the branded store-value card may include any suitable use. Acceptable uses for funds may include any suitable use. Restrictions may be for the use of branded store-value cards and/or funds. The restrictions may prohibit using gift funds and/or branded store-value card for any illegal uses. The restrictions may prohibit using gift funds and/or branded store-value cards for gambling. The restrictions may prohibit using gift funds and/or branded store-value cards for the purchase of alcohol, tobacco, or cigarettes.

The restrictions may be offered as a predefined giving profile. A predefined giving profile may include predetermined restrictions. A predefined giving profile may include standardized restrictions. The restrictions may be standardized based upon the reason for the gift transfer. An exemplary profile may prohibit the use of branded store-value cards and/or gift funds for alcohol and gambling. In another example, the profile may allow the use of branded store-value cards and/or gift funds for tuition and rent. The profile may be titled the “Grandchild Profile,” or any other suitable title.

The intermediary may offer preset restrictions. The preset restrictions may include restrictions on illegal activity. The preset restrictions may include restrictions on all activity not suitable for a specific age group. The restrictions may include restrictions on a purchase amount in one transaction. For example, a branded store-value card given to a twelve year old may prohibit the purchase of a computer.

The restrictions may be customized by the donor. The donor may select certain categories of activities to prohibit. For example, the donor may prohibit the gift funds from being used to purchase electronics and/or food. The donor may select certain payees that are prohibited. The donor may select a specific transaction limit.

Unacceptable uses of the funds may be prevented. The account may be configured to request permission to proceed with an unacceptable use of the funds. The account may be configured to automatically decline unacceptable uses of the funds. The account may be configured to prevent further usage of the account, whether such further usage is acceptable or unacceptable, once an unacceptable use of funds has been attempted.

The account may be configured to automatically close in the event an unacceptable use is attempted. The account may be configured to offer the donor an option to close the account. The account may be configured to refund the value of improperly used funds to the donor.

The account may be configured to prevent the donor from taking funds out of the account. The donor may be prevented from taking funds transferred into the account by the donor.

An acceptable use of gift payments may be to repay a debt. The gift payment may be intended to pay a specific debt. The debt may be specified by the donor or the beneficiary. The gift payment may be for the entire amount of the debt owed by the beneficiary. The gift payment may be for a portion of the debt owed.

The donor may instruct the intermediary to make a one-time transfer of funds for the payment of a debt. The donor may instruct the intermediary to make recurring payments to the same payee for the payment of a debt.

The gift payment may be for a future payment to be owed by the beneficiary. The gift payment may be for a future obligation of the beneficiary. For example, a grandmother may be aware that her grandson's student loans are due in six months, and the grandmother may make a gift payment on the future debt.

The gift may be earmarked to pay bills. The gift may be earmarked to pay specific types or categories of bills. The gift may be transferred directly to the donee. The gift may be used for any suitable purpose as determined by the donee.

The donor may earmark funds that are transferred to the beneficiary. The funds may be marked for use only in specific transactions. The mark may include an electronic tag or watermark on the transferred gift payment. The mark may include a written set of instructions accompanying the transfer request.

The donor may instruct the intermediary to restrict use of the gift funds to certain types or categories of transactions. The types or categories of transactions may be specified by the donor. The donor may select the categories from a list provided by the intermediary. There may be a list of preapproved categories eligible to receive gift payments. For example, a grandmother may give a $1000 gift to her grandson that can be used only to pay for food.

The donor may specify that the funds only be disbursed to a specific payee. There may be a list of preapproved payees. For example, a grandmother may give $1000 to her grandson to be used only at Barnes & Noble.

The donor may specify that the funds only be used for certain Merchant Category Codes (“MCC”). The donor may specify certain MCC's that are prohibited. The donor may restrict the use of funds to a preselected group of certain MCC's.

The donor may specify that a branded store-value card only be used for certain MCC's. The MCC's be preselected by an intermediary. The MCC's may be preselected by a donor. The donor may specify that a branded store-value card is prohibited from being used for certain MCC's. For example a donor may specify that a branded store-value card may not be used for the MCC's that encompass gambling or cigar stores. In a further example, a donor may restrict the use of gift funds to MCC's directed to clothing or food purchases.

The account may be titled in the name of the beneficiary. The account may be an escrow account. The escrow account may be opened with specific instructions for use of the funds. The instructions may be submitted by the donor. The instructions may be submitted by the beneficiary. The instructions may be submitted by the intermediary.

The escrow account may be configured to release funds only when an approved payee is selected by the beneficiary. The escrow account may be configured to automatically prevent the release of funds from the account when an unapproved payee is selected.

The escrow account may be further configured to release funds only when an appropriate payment amount is selected by the beneficiary. The escrow account may be configured to automatically prevent the release of funds from the account when an unapproved payment amount is selected.

The donor may instruct the intermediary to hold the transferred funds in an account. The account may be a presently-existing account of the beneficiary. The intermediary may open a special account to hold the funds. The account may be specially configured to service gift payments. The account may be automatically monitored to ensure compliance with donor instructions.

The donor may open a new account in the name of a payee. The donor may open a new account in the name of a beneficiary. The payee may set up an account for the purpose of receiving gift payment transfers.

The beneficiary may refuse receipt of the transferred gift. The beneficiary account may be configured to display a clickable button. When clicked, the clickable button may be configured to allow a beneficiary to refuse receipt of the gift.

The intermediary may have access. The intermediary may have the right provide access to a donor. The access may include access to account information. The account information may include information about the transferred funds. The intermediary may establish unique log-in information to view information related to the transferred funds.

The intermediary may offer different categories of access for an account. The intermediary may offer an account with restricted access. Restricted access accounts may limit the access of the beneficiary. Restricted access accounts may limit the access of the donor.

An account may be a joint account. The joint account may be opened for the purpose of servicing the gift transfer. The joint account may be fully accessible to a donor and/or a beneficiary and/or a donee. The joint account may offer limited accessibility to the donor and/or beneficiary.

An account may be a limited access account. A limited access account may be configured to grant partial access to the donor. A limited access account may be configured to grant partial access to the beneficiary. A limited access account may be configured to grant unlimited access to a donor. A limited access account may be configured to grant unlimited access to a beneficiary.

A limited access account may be configured with restrictions. The restrictions may be preselected by an intermediary. The intermediary may offer a selection of restrictions. The restrictions may be customized by a donor and/or beneficiary. The donor and/or beneficiary may specify restrictions on what portions of an account can be accessed. For example, a beneficiary may inform Bank C that the donor may only view the balance of the account, but cannot view specific transactions.

The account may be configured to prevent viewing access. The account may be configured to send out account alerts and/or notifications. Restricted access may allow for a beneficiary and/or donor to prevent viewing access, but allow for another party to receive account alerts. For example, a beneficiary may instruct Bank D to restrict the donor's view of the account such that no information may be viewed by the donor. In a further example, the beneficiary may instruct Bank D to send alerts to the donor that the account balance is low, or has fallen below a specified level. In yet another example, the beneficiary may instruct Bank E to send alerts to a donor when an overdraft occurs on the account.

Restricted access accounts may be configured to allow full access for limited periods. Restricted access accounts may be configured to grant full access only in certain situations. The donor and/or beneficiary may be provided with a secure link and/or code to access the account. The situations may be preselected by a beneficiary. Situations may include a low account balance, overdraft occurrence, multiple bills, or any other suitable occasion.

The account may be configured to allow full access for a certain time period. The time period may be specified by the donor and/or beneficiary. The time period may be any suitable time period. For example, a beneficiary may instruct Bank C to allow unrestricted account access to a donor only when the account balance falls below $200, or any other suitable number. In a further example, the beneficiary may instruct Bank C to allow unrestricted account access to a donor for 24 hours, or any other suitable time period.

Access may include the ability to view account details. Access may include the ability to limit account interactions. Account interactions may include making payments, transfers, depositing funds, withdrawing funds, initiating a loan, or any other suitable activity. A donor may restrict the access of a beneficiary. A beneficiary may restrict the access of a donor.

The intermediary may offer an account with permitted access. Permitted access may give a beneficiary full access to an account. Permitted access may give a donor full access to an account. A donor may be grant permitted access to a beneficiary. A beneficiary may grant permitted access to a donor.

The account may be configured to provide donor access to the account. Access to the account may provide a graphical view of the account. The graphical view of the account may vary based on access level.

The donor's graphical view of the account may differ from the beneficiary's view. The donor may restrict the beneficiary's graphical view of the account. The beneficiary may restrict the donor's graphical view of the account. The view of the account may be restricted based on whether the beneficiary has restricted access. The view of the account may be restricted based on whether the donor has restricted access.

The donor may view activity of the beneficiary. The donor may view beneficiary payments. The donor may view beneficiary transactions. The donor may view beneficiary transfers. The donor may view any suitable activity that the beneficiary takes through the account.

The beneficiary may view the donor's activity for the account. The account may be configured to display all donor activity for the account. The account may be configured to display none of the donor's activity for the account. The account may be configured to display some of the donor's activity for the account. The donor may choose which activities to display. The beneficiary may choose which activities of the donor to display.

The account may be configured to allow the donor to view the bills or obligations of the beneficiary. All bills of the beneficiary may be viewable by the donor. None of the bills of the beneficiary may be viewable by the donor. A portion of the bills may be viewable by the donor. The bills may be viewable based on the donor's level of access to the account. The donor may access a display of the bills.

Each bill may be viewable in its entirety. Each bill may be partially viewable. A portion of the bill may be redacted. The redaction may depend on the donor's level of access.

A payee may restrict access to the beneficiary. The payee may restrict access to the donor. The payee may redact a portion of the bill. The redaction may apply only to the beneficiary. The redaction may apply only to the donor.

The bills may be input into the account by the beneficiary. The bills may be input into the account by a payee or creditor. The bills may be input into the account by the intermediary. The account may be configured to amass all bills relevant to the beneficiary.

The intermediary may confirm the authenticity and/or accuracy of the bills. The intermediary may have a relationship with the payee. The relationship may allow the payee to input bills directly into the account. The relationship may allow the intermediary to extract bills from the payee servers.

The account may be configured to allow correspondence. Correspondence may include text, photographs, attachments or files. Correspondence may include asking questions, giving answers, requesting more information, submitting documents, asking for a transfer, asking for a payment, or any other suitable correspondence. The donor may interact with the beneficiary through the account.

The donor may correspond with the beneficiary through the account. The donor may initiate the correspondence. The beneficiary may initiate the correspondence.

The donor may interact with the payee through the account. The interaction may include the ability of the donor to ask detailed questions about the bills to the payee. The donor may specify which portions of the bill to pay. The donor may specify categories of the bill for which gift funds may not be used.

The beneficiary may correspond with the intermediary through the account. The beneficiary may correspond with a payee and/or creditor through the account. The donor may correspond with the intermediary through the account. The donor may correspond with a payee and/or creditor through the account.

The beneficiary may request, via the account, or other suitable media, additional funds from the donor. The request may contain details of previous account activity. The request may be certified by the intermediary. The request may include the option to approve the transfer of additional funds for a specific use.

The funds may be automatically transferred from the donor's account to the specified payee. The funds may bypass the account of the beneficiary. The funds may bypass the control of the beneficiary. The request may contain information relating to the need for additional funds.

The donor may request that the intermediary monitor the account. The monitoring may be performed automatically by a computer program or system. The monitoring may be manually performed by a human. The intermediary may assess and approve the validity of the beneficiary's request. The intermediary may provide this assessment as a value-added service. The intermediary may certify that the payee intended to receive the funds from the beneficiary's account is accurately represented.

The intermediary may automatically transfer the funds to the specified payee once the donor approves the transfer. The intermediary may provide no manner for the beneficiary to override the transfer once approved. Such methods are favorable, for example, to prevent fraud, deceit or dishonesty by the beneficiary.

The intermediary may ensure that the beneficiary does not misrepresent the payee to the donor. The intermediary may confirm the account or payment address of the payee. For example, a parent may contract with a bank to monitor the gift account of a child. The bank may verify that the child's request to use funds to pay monthly rent is sent to the child's actual landlord, and not used for some other purpose, such as a vacation.

The account may be configured to allow a donor to approve the use of funds. The donor may approve beneficiary use of funds from the account. The donor may void potential beneficiary use of funds from the account. The donor may decline beneficiary requests for use of funds.

The beneficiary may initiate the approval process for the use of funds. The beneficiary may request, via the account, approval for use of funds. The beneficiary may submit a request prior to initiating a payment or transfer. The account may be configured to require approval prior to initiation of a payment or transfer.

The account may be configured to require approval after initiation of a payment or transfer. The beneficiary may request approval for use of funds once a payment is initiated. The request may be submitted before the transfer or payment is completed. The account may be configured to not require any manner of approval for initiation of a payment or transfer.

The donor of a gift payment may request that he remains anonymous to the beneficiary. The donor may issue an anonymous gift transfer directly to the beneficiary. The anonymous gift transfer may be marked for use in specific transactions or occurrences. For example, a donor may transfer a gift as an act of charity to a neighbor for the payment of a mortgage bill. In another example, the donor may transfer the gift payment anonymously, such that the beneficiary does not know who donated the mortgage payment.

The beneficiary may be notified that an anonymous gift has been transferred. The beneficiary may be notified when the anonymous gift is transferred to the beneficiary's account. The beneficiary may be notified when an anonymous gift is transferred to an intermediary for the benefit of the beneficiary. The beneficiary may be notified when an anonymous gift is transferred to a payee on behalf of the beneficiary. The beneficiary may be notified when an anonymous gift is transferred to a creditor on behalf of the beneficiary.

An account may be configured to allow a beneficiary to choose whether to be notified of anonymous gift transfers. An account may be configured to allow a donor to choose whether the beneficiary is notified of anonymous gift transfers. The beneficiary may not be notified that an anonymous gift has been transferred.

The anonymous gift may be deposited in a special account. The donor may have access to the special account. The donor may anonymously view activity of the beneficiary. The donor may anonymously interact with the beneficiary through the account. The donor may anonymously approve beneficiary use of funds from the account. The donor may anonymously void potential beneficiary use of funds from the account. The beneficiary may request, via the account, approval for use of funds.

The donor may make an anonymous gift transfer directly to a payee. The donor may instruct the payee to apply the gift payment to a beneficiary's account balance. The intermediary may notify the beneficiary that a payment has been made on the beneficiary's behalf.

Some embodiments may include a two-step notification process in connection with the gift. In the two-step notification process, the first step may be that a donor commences a gift transfer. The second step may be that the intermediary notifies the beneficiary that a gift has been made.

Some embodiments may include a three-step notification process. The three-step notification process is similar to the two-step notification process, but may include, as a third step, that the intermediary notifies the donor that the beneficiary has utilized or attempted to utilize a portion of the gift funds. In some embodiments, the third step may comprise a notification sent to the donor that the beneficiary is aware of the gift transfer.

The notifications may be executed by any suitable paper or electronic communication, including postal letter, electronic mail, text message, telephone, fax or any other suitable communication. The notification may be automatically stored in a database for future reference.

The donor may include an attachment with the gift. The attachment may be an object, text, file, picture or comment box. The attachment may include a message. The message may state that the payment is a gift payment. The message may include the payment amount. The message may contain a personalized statement or note. The attachment may include a virtual greeting card. The virtual greeting card may be animated. The virtual greeting card may include an audio component. The virtual greeting card may include a video component. The virtual greeting card may state a purpose and an indication for the gift.

The attachment may be sent to the beneficiary. The attachment may be sent to the payee. The attachment may inform the payee of the purpose of the payment. The attachment may identify the beneficiary of the payment. The attachment may include beneficiary account information.

Attachments may include a greeting card. The greeting card may contain photographs, text, or details of a gift. The greeting card may be an electronic file. The electronic file may be linked to a financial account. The greeting card may be provided by an intermediary. The intermediary may offer a selection of greeting cards. The selection of greeting cards may be configured to match a type of gift. The type of gift may be based upon the occurrence of a milestone or event. The greeting card may be linked to a branded store-value card. The greeting card and/or branded store-value card may be configured to open a new account upon activation. The new account may be opened for servicing the branded store-value card.

Apparatus and methods of the invention may be implemented on a mobile device. A mobile device may include a personal digital assistant (“PDA”), pager, smartphone, laptop computer, tablet, tablet computer, wireless telephone, portable display device, handheld device, mobile communication device, or any other suitable device. For example, a donor may access his or her account using his or her smartphone, and initiate a gratuitous transfer of funds. In a further example, the beneficiary of the gratuitous transfer of funds may access his account on his tablet computer and make a payment directly from the tablet computer.

In some embodiments, the apparatus and methods may provide optional file attachments that may be communicated from a donor (initiator) to a recipient. Such attachments might include a signed contract for products or services, a payment stub with descriptive details of the payment, a photo of an item being purchased, or any other document that the donor wishes to send in connection with the payment transaction. In other embodiments, the data to be passed from donor to beneficiary with the payment could be comprised of one or more text/comment fields.

The gift transfer may include attachments. The attachment may be a note. The note may be virtually or electronically attached to a branded store-value card. The note may be attached by a donor. The note may be attached by a third party. The note may be attached by a group of donors. Each of the donors may be allowed to personalize his or her own note. Each of the personalized notes may be included as part of a branded store-value card.

Attachments may take the form of electronic files. The files may be uploaded to a payment intermediary, such as a bank, a billpay service, a billpay network, or any other suitable intermediary. The attachments may originate as a file from the donor's computer, a scan from a scanner, a fax, a photo, an audio and/or video recording, or any other means of electronic document capture. An attachment may be in any suitable data format, such as DOC, PDF, TIFF, WAV, MP3, or JPEG.

In some embodiments of the invention, the payment intermediary may set limits on the attachments, such as size, file type, etc. The intermediary may scan the attachment for malware or inappropriate content to prevent intentional or unintentional dispersion of malicious software code, digital rights violations, or harassing images or content.

Furthermore, the attachment may be made available to the beneficiary whether or not the beneficiary is a customer or member of the payment intermediary (bank, network, or otherwise) and whether the payment was made electronically (e.g., by Automated Clearing House (“ACH”) or other method) or by paper (check, draft, etc.) In the case of electronic payment, the beneficiary may be provided with a preferably secure link that would enable the payee to view or download the attachment. In the case of paper payment, the beneficiary may be provided with instructions and a file-code or link-name that would take the beneficiary to view or download the attachment. In the case of paper payment, the beneficiary may be provided with a paper copy of the attachment.

In the case of one or more text/comment fields comprising the attachment, the contents of the field(s) could be passed directly in the electronic payment record, space permitting according to accepted industry or party standards, or could be made available for retrieval via a two-step or three-step process as detailed below.

Some embodiments may include a two-step attachment/notification process in connection with the attachment. In the two-step attachment/notification process, the first step may be that a donor attaches the attachment to a payment. The second step may be that the intermediary notifies the beneficiary about the attachment. Some embodiments may include a three-step attachment/notification process. The three-step attachment/notification process is similar to the two-step attachment/notification process, but may include, as a third step, that the intermediary notifies the donor that the beneficiary has viewed or retrieved a copy of the attachment. The notifications may be executed by any suitable paper or electronic communication, including postal letter, electronic mail, text message, telephone, fax or any other suitable communication. The notification may be automatically stored in a database for future reference.

In certain embodiments of the invention, the donor and/or the beneficiary can set preferences regarding the notifications. Such preferences may include whether the donor wants to receive them at all, whether to selectively receive the notifications based on parameters such as a size of transaction, merchant and/or type of transaction. Another preference regarding the reporting of the notifications may include when and/or at what intervals the notifications are provided to the donor. For example, the notifications may be provided in real time or provided in a batch processing format at some predetermined interval. Another preference regarding the reporting of the notifications may include whether or not indications are provided to the donor when reviewing a transaction history or statement and whether such information is reported in detailed or summary formats.

The two-step attachment/notification may be useful for giving notice to the beneficiary that the donor has made a payment that is substantiated, qualified, conditioned or otherwise modified. The three-step attachment/notification may be useful for giving the donor notice that the beneficiary has accessed the attachment. This may give the donor an opportunity, for example, to timely contact the beneficiary to resolve unapproved use of gift funds.

In some embodiments, the intermediary may provide to both the donor and the beneficiary the capability to view, print, save, and/or send an attachment related to a payment.

In some embodiments, the apparatus and methods may be used in connection with Electronic Data Interchange (“EDI”) platforms and the like. Typically, a financial institution (such as a bank) may receive billpay instructions from a large number of its customers to transfer funds and/or a branded store-value card a single beneficiary or payee (such as a credit card company) that is common to all of the donors.

EDI-based transactions enable the financial institution to pay the common payee and/or beneficiary by transmitting to the payee a single sum of funds along with a list that identifies the donors, the individual payment amounts to be credited to the donors' accounts and any appropriate supporting information. When the common payee and/or beneficiary receives the sum, it allocates the sum among the payors' or donors' accounts.

The invention may provide apparatus and methods by which an individual donor may attach information to a billpay record that will be incorporated into an EDI-based transaction. In some embodiments, billpay attachments from the donors may be transmitted as an electronic “bundle” of attachments. The attachments may be transmitted together with, or separately from, the list of donor identifiers. The financial institution may provide to the beneficiary cross-reference information that links a donor, or a donor account, to a corresponding attachment.

EDI standards were developed by the American National Standards Institute (ANSI) to promote electronic commerce. EDI standards for numerous types of transactions are available. For example, EDI standards are available for purchase orders and invoices. In EDI, all data field names, types, formats, lengths and other data parameters are defined in a data dictionary. EDI platforms may be used by billpay organizations to serve their clients. In the context of the financial services industry, a bank, for example, may be the billpay (or intermediary) organization. A payor or donor may be, for example, a client, customer or account holder of the bank. Clients, beneficiaries, or partners may be individuals, organizations, business or government entities. The use of EDI with the invention is set forth in more detail below.

EDI platforms typically communicate at the system-to-system level using structured data. EDI platforms may support the processing of data in any suitable format, such as ANSI X12, CEFACT and EDIFACT. EDI platform data may be translated for interfacing with any suitable accounting systems, such as accounts payable and accounts receivable systems.

In some embodiments of the invention, the apparatus may be used in connection with eCommerce systems. Ecommerce systems operate at different levels. Some are system-to-system. Some are people-to-system. Some are people-to-people. Ecommerce systems may support the use of structured or unstructured data. Ecommerce systems may support the use of data in any suitable format. For example, ecommerce systems may support the use of EDI data, XML data or any other suitable type of data. Ecommerce systems may be part of any suitable commerce system, such as a financial supply chain management system (enterprise resource planning (“ERP”) systems, for example).

Transaction intermediaries using EDI or another platform may process a large volume of payment instructions from a single client. The instructions may be combined into a single electronic file. The payments may be made to domestic beneficiaries, foreign beneficiaries or both. The payments may include domestic wires, international wires, including Bulk FX wire, or both domestic and foreign wires. The payments may be effected by domestic check or draft, international check or draft. The checks and drafts may be printed in any suitable language.

EDI platforms are compatible with numerous billpay modules, numerous client transmission platforms, and client internal systems. Table 1 shows exemplary EDI-compatible formats in connection with which the apparatus and methods of the invention may be used to attach a data object to an electronic transaction record.

TABLE 1
Illustrative Payment Network Origination Module Formats

| Format | Illustrative usage |
|---|---|
| X12 - 820 | Payment Order/Remittance Advice |
| X12 - 835 | Health Care Claim Payment/Advice |
| X12 - 831 | Control Totals |
| X12 - 828 | Debit Authorization (Checks Issued) |
| EDIFACT - | PAYEXT Extended Payment Order Message |
| EDIFACT - | DIRDEB Direct Debit Message |
| SAP IDOC | SAP Intermediate Document |
| TD-CPA | (Canadian ACH payments) |
| FIRM - | Japanese Low-Value Clearing (Zengin) |
| CSV - | Comma Delimited |
| XML | |

Table 2 shows exemplary EDI-compatible client transmission platforms in connection with which the apparatus and methods of the invention may be used to attach a data object to an electronic transaction record.

TABLE 2
Illustrative Client Transmission Platforms
Client Transmission Platforms

VAN (Value Added Network)
DTS (Data Transmission Support)
Swift FileACT
GBS (Global Banking Systems)
EFD - Bank Direct
Fax

Table 3 shows exemplary client internal systems with which the apparatus and methods of the invention may be used.

TABLE 3
Illustrative Client Internal Systems
Client Internal Systems

Tandem - ECS
Mainframe - Connexion
Info Utility - EIU

Apparatus and methods for electronically executing a transaction between a donor and a beneficiary are provided. The apparatus and methods may involve receiving an electronic request from the donor. The request may be a request to transmit funds to the beneficiary. The donor may include a data object in the transaction. The data object may include information that the donor selects. The information may relate to the transaction, terms of the transaction, prior communications between the donor and the beneficiary, prior communications among the donor, the beneficiary and a third party. The data object may be an electronic file, an electronic folder, or any other suitable data structure. The data object may be formatted as an image, text, audio, video or any other suitable format. The apparatus and methods may include establishing an electronic link between the data object and the beneficiary.

Some embodiments of the invention may involve providing access to online billpay information that corresponds to a transaction between a donor and a beneficiary. The apparatus and methods may involve receiving an electronic request from the donor. The request may be a request to transmit funds to the beneficiary. The apparatus and methods may include receiving a data object that the donor has selected for inclusion in the transaction. The data object may be stored in a database. A pointer may be provided. The pointer may point from a stored record of the transaction to the data object. A request for the billpay information may be received from the donor. In response to the request, the billpay information may be provided to the donor.

The apparatus and methods of the invention may be used by leveraging any suitable billpay software, such as Fiserv/CheckFree, by any suitable intermediary offering payment services, such as banks, and by any suitable payment networks, such as PayPal®.

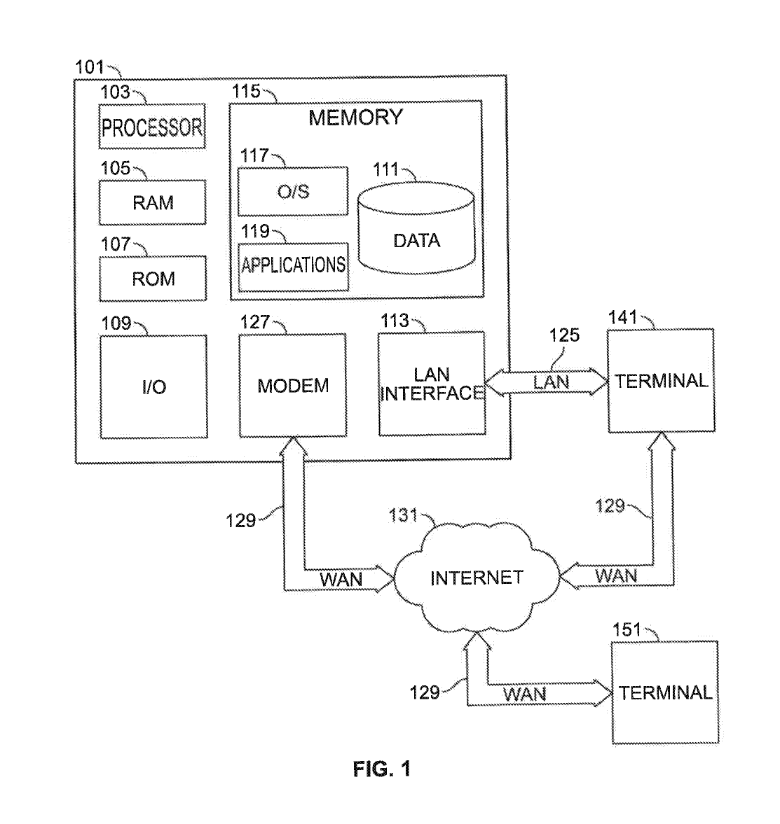

FIGS. 1-8 show illustrative embodiments and features of the invention.

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope and spirit of the present invention.

As will be appreciated by one of skill in the art upon reading the following disclosure, various aspects described herein may be embodied as a method, a data processing system, or a computer program product. Accordingly, those aspects may take the form of an entirely hardware embodiment, an entirely software embodiment or an embodiment combining software and hardware aspects.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

FIG. 1 is a block diagram that illustrates a generic computing device 101 (alternatively referred to herein as a “server”) that may be used according to an illustrative embodiment of the invention. The computer server 101 may have a processor 103 for controlling overall operation of the server and its associated components, including RAM 105, ROM 107, input/output module 109, and memory 125.

Input/output (“I/O”) module 109 may include a microphone, keypad, touch screen, and/or stylus through which a user of device 101 may provide input, and may also include one or more of a speaker for providing audio output and a video display device for providing textual, audiovisual and/or graphical output. Software may be stored within memory 125 and/or storage to provide instructions to processor 103 for enabling server 101 to perform various functions. For example, memory 125 may store software used by server 101, such as an operating system 117, application programs 119, and an associated database 121. Alternatively, some or all of server 202 computer executable instructions may be embodied in hardware or firmware (not shown). As described in detail below, database 121 may provide storage for account information, account holder information, account application data and statistics, and any other suitable information.

Server 101 may operate in a networked environment supporting connections to one or more remote computers, such as terminals 141 and 151. Terminals 141 and 151 may be personal computers or servers that include many or all of the elements described above relative to server 101. The network connections depicted in FIG. 1 include a local area network (LAN) 125 and a wide area network (WAN) 129, but may also include other networks. When used in a LAN networking environment, computer 101 is connected to LAN 125 through a network interface or adapter 113. When used in a WAN networking environment, server 101 may include a modem 127 or other means for establishing communications over WAN 129, such as Internet 131. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, application program 119, which may be used by server 101, may include computer executable instructions for invoking user functionality related to communication, such as email, short message service (SMS), and voice input and speech recognition applications.

Computing device 101 and/or terminals 141 or 151 may also be mobile terminals including various other components, such as a battery, speaker, and antennas (not shown).

A client of a financial institution may use a terminal such as 141 or 151 to leverage the systems and methods of a billpay platform administered by an intermediary. The client may communicate with the intermediary using a transmission platform such as one of those listed in Table 2. Billpay information, including beneficiary information, donor information, historical transaction records, data objects for attachment, and any other suitable information, may be stored in memory 125. Applications 119 may include a payment origination module such as one of those listed in Table 1.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, mobile phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

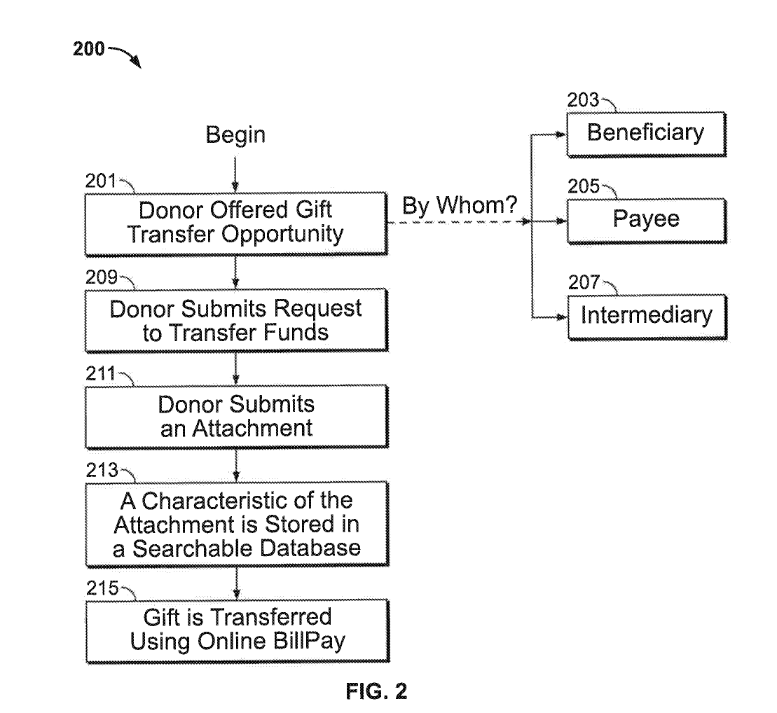

FIGS. 2-5 show illustrative processes. For the sake of illustration, the process will be described as being performed by a system. The system may include one or more of the devices shown in FIG. 1, one or more individuals and/or any other suitable device or approach.

FIG. 2 shows illustrative process 200 for transferring a gift payment using online billpay systems and methods to give the gift. The payment may be part of a transaction between parties such as a donor and a beneficiary. At step 201, a donor may be offered a gift transfer opportunity. The gift transfer opportunity may be an opportunity to donate funds to a charity. The gift transfer opportunity may be an opportunity to pay a bill of another party. The gift transfer opportunity may be an opportunity to grant funds to a friend and/or family member.

The gift transfer opportunity may be offered to the donor by beneficiary 203, payee 205, or intermediary 207. Beneficiary 203 may be a donee. Payee 205 may be a creditor of the beneficiary. Intermediary 207 may be a bank and/or financial institution. Intermediary 207 may service an account of the beneficiary. Intermediary 207 may service an account of the donor. Intermediary 207 may service an account of the payee.

The gift transfer opportunity may be initiated by any or all of beneficiary 203, payee 205, or intermediary 207. Beneficiary 203 may contact the donor with the gift transfer opportunity. Beneficiary 203 may contact intermediary 207 with the gift transfer opportunity. Beneficiary 203 may ask intermediary 207 to contact the donor with the gift transfer opportunity. Beneficiary 203 may contact payee 205. Beneficiary 203 may ask payee 205 to contact the donor with the gift transfer opportunity.

Payee 205 may contact the donor with the gift transfer opportunity. Payee 205 may contact beneficiary 203. Payee 205 may ask beneficiary 203 to contact the donor with the gift transfer opportunity. Payee 205 may contact intermediary 207. Payee 205 may ask intermediary 207 to contact the donor with the gift transfer opportunity.

Intermediary 207 may contact the donor with the gift transfer opportunity. Intermediary 207 may contact beneficiary 203. Intermediary 207 may ask beneficiary 203 to contact the donor with the gift transfer opportunity. Intermediary 207 may contact payee 205. Intermediary 207 may ask payee 205 to contact the donor with the gift transfer opportunity.

At step 209, the donor may submit a request to transfer funds. The request may be submitted to an intermediary. The funds may be transferred to beneficiary 203, payee 205, or intermediary 207.

At step 211, the donor may submit an attachment. The attachment may be text, photographs, files, a greeting card or a branded store-value card. The attachment may include instructions for use of the gift funds.

At step 213, a characteristic of the attachment may be stored in a searchable database. The searchable database may be maintained by an intermediary.

At step 215, the gift is transferred. The gift may be transferred using online billpay systems and methods. The gift may be transferred to an account. The gift may be transferred a physical branded store-value card. The gift may be transferred as a virtual branded store-value card.

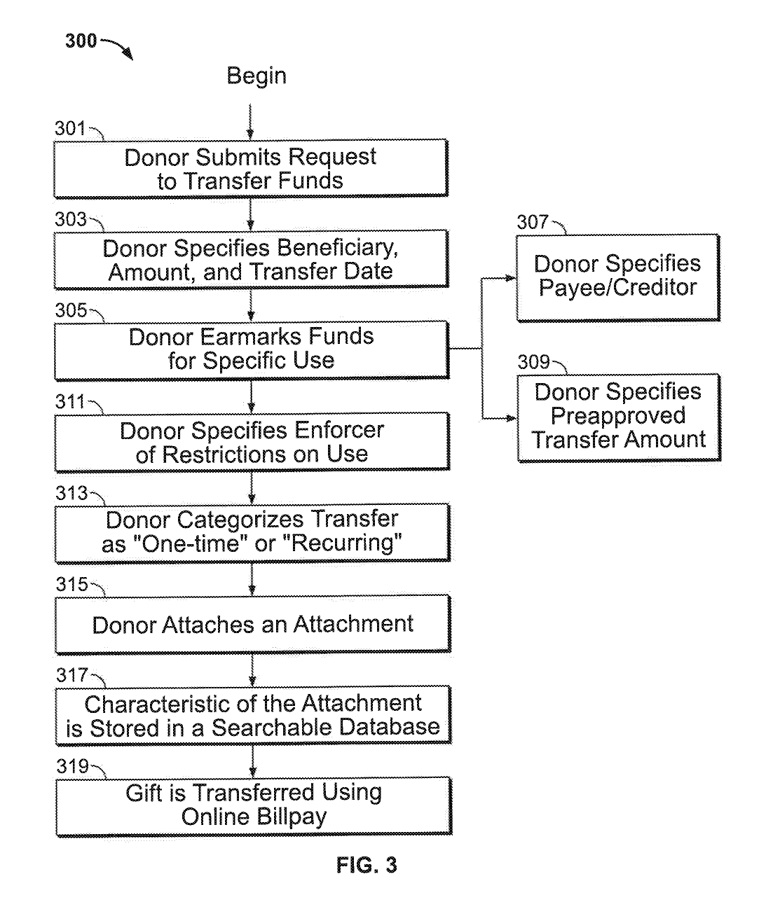

FIG. 3 shows illustrative process 300 for transferring a gift payment. The gift payment may be transferred using online billpay systems and methods to transfer the gift payment. The transfer may be initiated by a donor. The donor may be a client or customer of an intermediary. The intermediary may be, for example, a bank or an electronic billpay service.

At step 301, the donor may submit a request to transfer funds. The donor may submit the request to an intermediary. The donor may submit the request due to a petition for funds from a beneficiary. The donor may submit the request on its own accord. The donor may submit the request due to a petition for funds from a payee. The donor may submit a request due to a petition for funds from a beneficiary.

At step 303, the donor may specify the beneficiary of the transfer. The donor may specify the amount to be transferred. The donor may specify the transfer date. The donor may specify multiple beneficiaries.

At step 305, the donor may earmark the funds for specific use. The earmark may be an electronic tag. The earmark may be a digital watermark.

The donor may request from an intermediary to ensure sure that the funds are used only for a stated purpose. The intermediary may offer the donor an option to earmark funds. The option may be presented in a graphical display. The donor's account may be configured to automatically offer funds to be earmarked whenever a gift payment transfer is initiated. Account serviced by an intermediary may be configured to offer earmarks whenever a payment transfer is initiated.

The intermediary may make preconfigured categories of earmarks available. The donor may specify more than one category of suitable uses for the funds. The donor may specify more than one category of unsuitable uses for the funds.

At step 307, the donor may ask an intermediary to ensure that the funds are transferred from the beneficiary to one or more payees or creditors. The intermediary may offer the donor an option to earmark funds only for certain payees or creditors. The option may be presented in a graphical display.

The intermediary may offer a list of common payees to earmark. The donor may specify one or more payees from the list. The specified payees may be earmarked for receiving funds, or earmarked for their ineligibility to receive funds. The donor may specify one or more payees independent of the list.

At step 309, the donor may specify a preapproved transfer amount. The transfer amount may limit the amount of funds to be paid to a given payee. The amount may be an aggregate amount. The aggregate amount may set a limit for total funds that may be disbursed to a given payee during the lifetime of the account.

The preapproved transfer amount may be a limit on gift fund disbursement by the beneficiary to a given payee in any given time period. Examples of a time period include: hourly, daily, weekly, biweekly, monthly, bimonthly, annually and biannually.

For example, a parent may specify that only $200 may be used by the son to pay for food. The parent may further specify that the $200 limit applies on a monthly basis, or for any other suitable period. In a further example, a parent may specify that only $100 may be spent at Restaurant B. The parent may specify that the $100 limit applies on a weekly basis, or any other suitable time period.

The preapproved transfer amount may be an aggregate limit applying to all usage of funds in a given time period. The preapproved payment amount may limit the amount of funds to be paid to all payees in total during a given time period. For example, a grandmother may specify that only $500 may be used by her grandson during a specified time period.

At step 311, the donor may nominate an entity to enforce restrictions on usage of funds by the beneficiary. Such restrictions may include ensuring that earmarked funds are used for the proper purpose. Further restrictions may include that funds are transferred only to proper payees and/or only for the specified payment amounts. The entity may be an intermediary. The intermediary may be the donor's bank or financial institution. The intermediary may be a different bank or financial institution. The intermediary may be the beneficiary's bank or financial institution. The intermediary may be the payee's bank or financial institution. The entity may be a third party offering account monitoring. The account monitoring may ensure compliance with gift account requirements.

At step 313, the donor may categorize the transfer as “one-time” or “recurring.” One time transfers may be deactivated after the transfer is made. Deactivated transfers may be reactivated at a later date. The reactivated transfer may be identical to the initial transfer.

Recurring transfers may have a set frequency of recurrence. Recurring transfers may have a variable frequency of recurrence. The frequency may be determined by the donor. The frequency may be determined by the beneficiary. Examples of frequency may include: hourly, daily, weekly, biweekly, monthly, bimonthly, annually and biannually.

Recurring transfers may be set to occur upon the occurrence of a particular triggering event. The triggering event may be a low account balance. The triggering event may be an occurrence in the life of the donor and/or beneficiary.

Recurrence of transfers may be left to the discretion of an intermediary. An intermediary may determine when a beneficiary is in need of a transfer. The need for a transfer may be determined by liquidity, outstanding bills, account balance of the beneficiary, account balance of the donor, beneficiary request, or other suitable factors.

At step 315, the donor may attach an attachment. The attachment may be a greeting card. The attachment may be a branded store-value card. The attachment may be text, a file, or photograph. At step 317, the attachment may be stored as a characteristic in a searchable database.

At step 319, the gift payment may be transferred. The transfer may use online billpay systems and methods. The gift may be transferred to the account of a payee or creditor. The gift may be transferred to the account of the beneficiary.

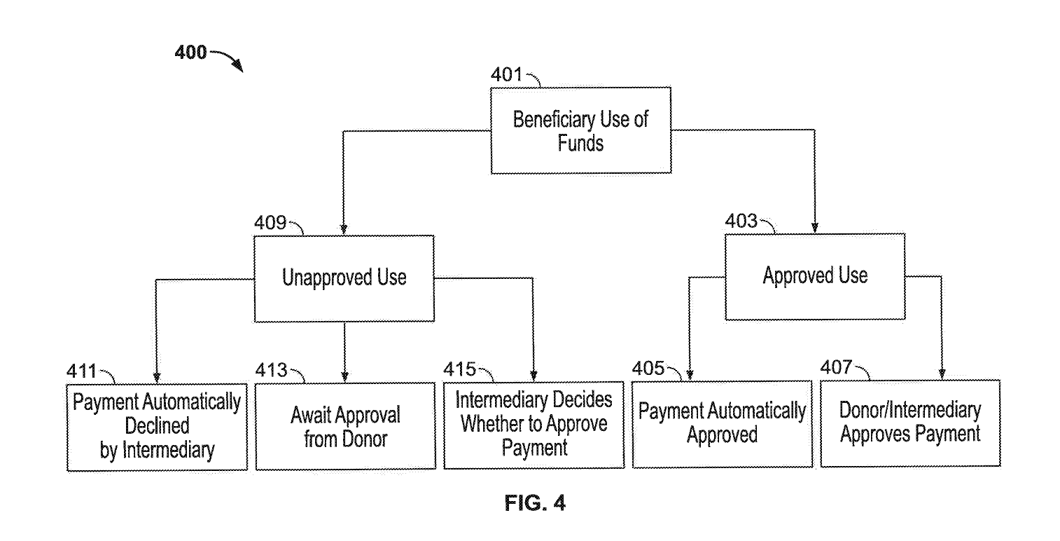

FIG. 4 shows illustrative process 400 for beneficiary use of funds. The process may include the use of any of the devices in FIG. 1.

At step 401, the beneficiary may decide to use gift funds. The gift funds may be in the beneficiary's account. The gift funds may be transferred from a donor. The gift funds may be transferred from an intermediary. The funds from the intermediary may have originated with a donor.

At step 403, the beneficiary may attempt to use the funds for a pre-approved use. The use may be pre-approved by the donor. The donor may select pre-approved uses from a list. The list may be provided by an intermediary. The donor may specify one or more pre-approved uses independent of a list. The use may be pre-approved by an intermediary. The beneficiary may be aware that pre-approval for use of funds is required. The beneficiary may not be aware that pre-approval for use of funds is required.

At step 405, the beneficiary may use the funds for an approved use. The use may be specified as an approved use. The use may not be enumerated as an approved use. The use may be absent from a list and/or selection of unapproved uses.

As a result of choosing a pre-approved use of funds, a payment or transfer may automatically be approved. Automatic approval for payments and/or transfers may be an option on an account. The option may be selected by the donor when opening the account. The option may be selected by the intermediary when the account is opened.

An automatically approved payment and/or transfer may be transferred to a payee or creditor. Automatically approved payments and/or transfers may be a one-time occurrence. Automatically approved payments and/or transfers may be set to occur on a recurring basis. Subsequent recurring transfers may require manual approval.

At step 407, the beneficiary may use the funds for an approved use. The use may be specified as an approved use of funds. The use may not be enumerated as an approved use. The use may be absent from a list and/or selection of unapproved uses.

The account may be configured to submit all requests for payments and/or transfers for approval. The approval may be granted by an intermediary. The approval may granted by the donor. The account may be configured to submit certain requests for payments and/or transfers for approval. The submission of certain requests for approval may be required. Such requests may be based on category of payment. Such requests may be based on payee.

The requirement for approval may be specified by the donor. The requirement for approval may be specified by the intermediary. The donor may specify certain categories requiring donor approval. The donor may specify certain payees requiring donor approval. The donor may specify certain categories requiring intermediary approval. The donor may specify certain payees requiring intermediary approval.

The intermediary may specify certain categories requiring donor approval. The intermediary may specify certain payees requiring donor approval. The intermediary may specify certain categories requiring intermediary approval. The intermediary may specify certain payees requiring intermediary approval.

The request to use funds for a pre-approved use may be submitted to the donor. The donor may approve the payment and/or transfer of funds. The donor may decline the use of funds. The request to use funds for a pre-approved use may be submitted to the intermediary. The intermediary may approve the payment and/or transfer of funds. The intermediary may decline the use of funds.

The account may be configured to automatically initiate a payment and/or transfer once the donor has approved the use. The account may be configured to notify the intermediary that the donor has approved the payment and/or transfer. The account may be configured to notify the beneficiary that the use has been approved. The account may be configured to notify a payee or creditor that the use has been approved. The intermediary may transfer the funds.

The account may be configured to automatically initiate a payment and/or transfer once the intermediary has approved the use. The account may be configured to notify the donor that the intermediary has approved the payment and/or transfer. The account may be configured to notify the beneficiary that the use has been approved. The account may be configured to notify a payee or creditor that that the use has been approved. The intermediary may transfer the funds.

At step 409, the beneficiary may attempt to use the funds. Use of the funds may be attempted for an unapproved use. Unapproved use of funds may be specified by the donor. Unapproved use of funds may be specified by the intermediary.

The donor may compile a list of specific unapproved uses. The donor may select one or more categories of unapproved uses. The selection may occur using any of the devices from FIG. 1. The donor may specify one or more payees or creditors as unapproved. The account may be configured to recognize specific unapproved uses. The account may be configured to categorize all uses specifically not approved as unapproved uses.

At step 411, the beneficiary may attempt an unapproved use for the funds. The unapproved use may be any suitable unapproved use. The unapproved use may include one or more characteristics and/or features of the unapproved use described in step 409. The beneficiary's payment and/or transfer may be automatically declined. The automatic declination may be by the intermediary. The intermediary may notify the donor of the declination.

At step 413, the beneficiary may attempt an unapproved use of funds. The unapproved use may be any suitable unapproved use. The unapproved use may include one or more characteristics and/or features of the unapproved use described in step 409.

The unapproved use may be submitted to the donor for consideration. The beneficiary may submit an attachment with the consideration request. The attachment may contain text. The text may include reasons for the requested use.

At step 415, the beneficiary may attempt an unapproved use of funds. The unapproved may be any suitable unapproved use. The unapproved use may include one or more characteristics and/or features of the unapproved use described in step 409.

The unapproved use may be submitted to the intermediary. The intermediary may determine whether to allow the unapproved use of funds. The donor may contract with the bank to provide this determination.

The intermediary may notify the donor of its determination. The intermediary may notify the beneficiary of its determination. The intermediary may notify a payee or creditor of its determination.

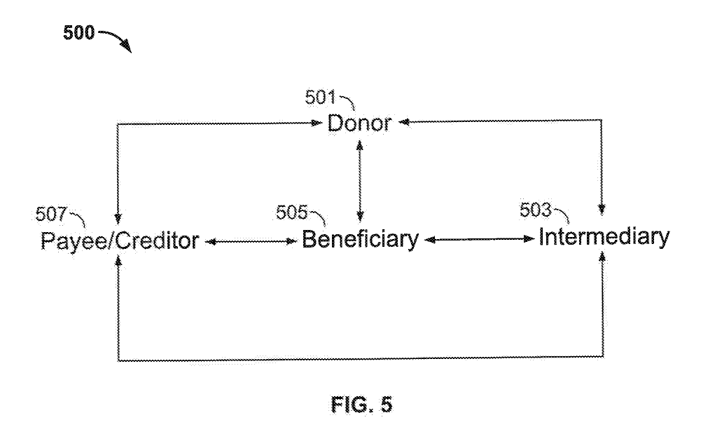

FIG. 5 shows illustrative interactions between different parties to a transfer or payment. Donor 501 may initiate a transfer. Donor 501 may transfer a gift to Beneficiary 505. Donor 501 may transfer a gift to Intermediary 503. Intermediary 503 may transfer the gift to Beneficiary 505. Donor 501 may instruct Intermediary 503 to transfer the gift to Beneficiary 505. Donor 501 may transfer a gift to Payee/creditor 507. Donor 501 may notify Payee/creditor 507 that the gift is to be used for the benefit of Beneficiary 505.

Intermediary 503 may initiate a transfer sequence. Intermediary 503 may contact Donor 501 about a payment or transfer opportunity. The opportunity may be for the benefit of Beneficiary 505. The transfer opportunity may result in a benefit to Payee/creditor 507. Intermediary 503 may transfer a gift to Payee/creditor 507. Donor 501 may instruct Intermediary 503 to transfer the gift to Payee/creditor 507.

Beneficiary 505 may initiate a transfer sequence. Beneficiary 505 may contact Donor 501 about a payment or transfer opportunity. Beneficiary 505 may request that Donor 501 transfer a gift payment to Beneficiary 505. The gift payment may be transferred to Beneficiary 505 account with Intermediary 503. Beneficiary 505 may contact Intermediary 503 about a payment or transfer opportunity. Beneficiary 505 may contact Intermediary 503 about a transfer or payment opportunity. Beneficiary 505 may request that Intermediary 503 notify Donor of a payment or transfer opportunity. Beneficiary 505 may transfer gift funds to Payee/creditor 507.

Payee/creditor 507 may initiate a transfer sequence. Payee/creditor 507 may notify Donor 501 of a potential payment or transfer opportunity. The payment or transfer opportunity may be a bill owed to Payee/creditor 507. The bill may be owed by Beneficiary 505. Payee/creditor 507 may notify Intermediary 503 of a payment or transfer opportunity. Payee/creditor 507 may notify Beneficiary 505 that a payment is due. Payee/creditor 507 may suggest that Beneficiary 505 request a gift payment from Donor 501.

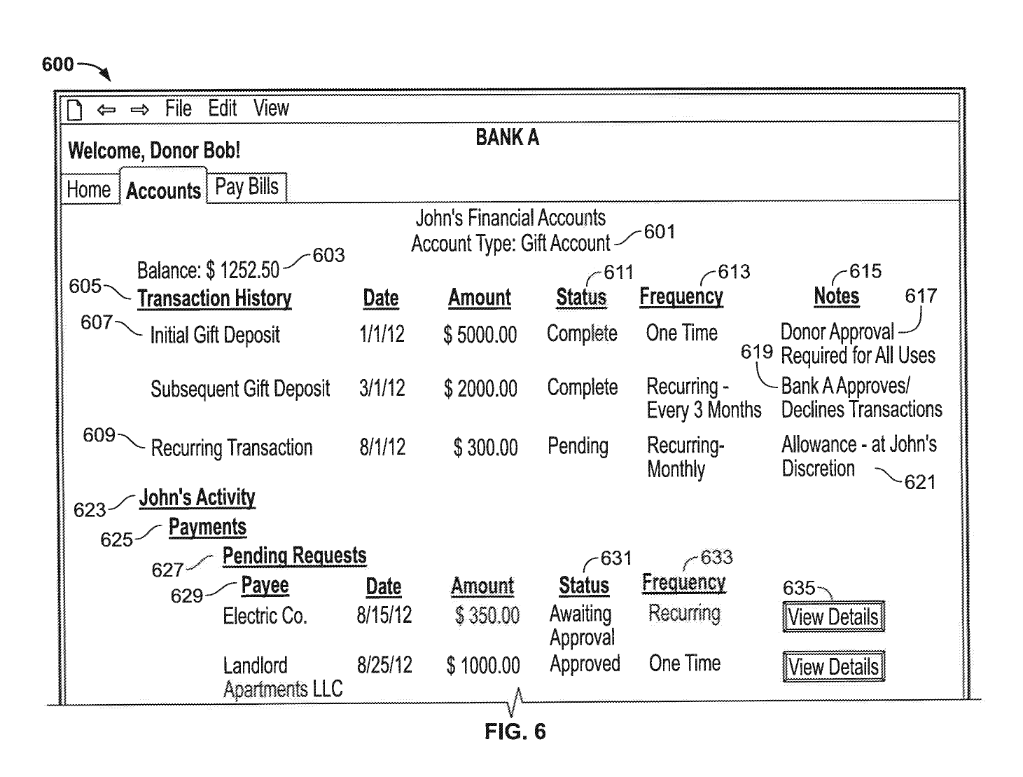

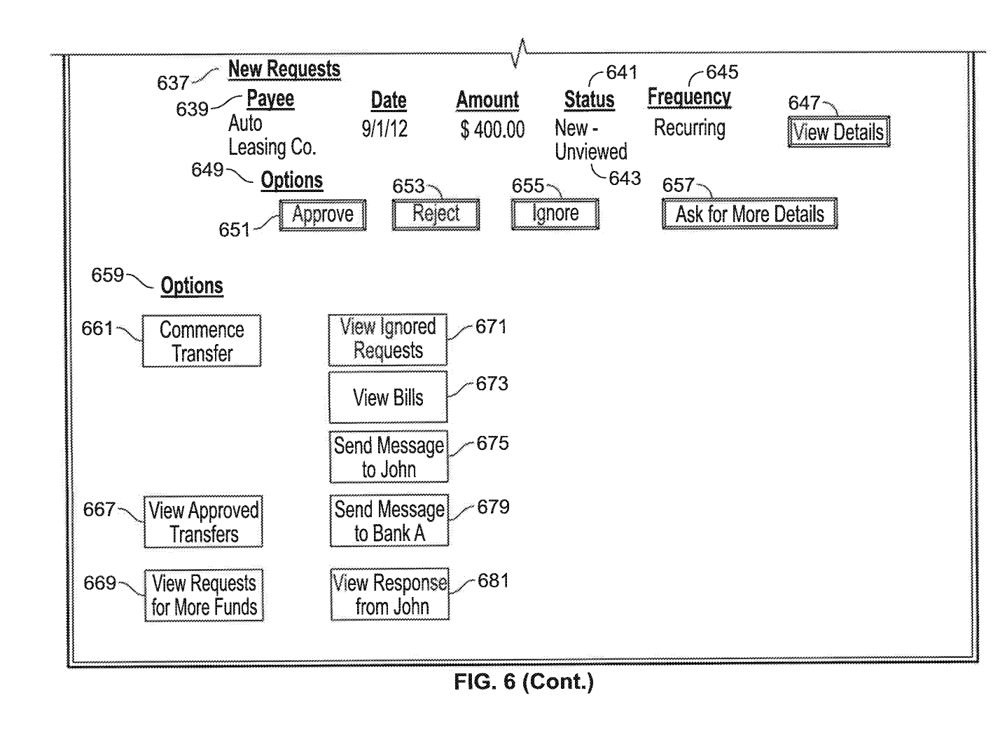

FIG. 6 shows an exemplary graphical display of account 600 that may be generated and displayed to the Donor in accordance with the systems and methods of the invention. FIG. 6 may include heading 601. Heading 601 may include information about the type of financial account being displayed. Heading 601 may state that the account is a gift account. Account 600 may include balance 603. Balance 603 may display the total balance in the gift account.

Account 600 may further include transaction history 605. Transaction history 605 may display all deposits made by a donor. Transaction history 605 may display all initial gift deposit 607. Transaction history 605 may display recurring transactions 609.

Transaction history 605 may display a number of columns with particular information about the transaction history. Columns may include information about deposit and/or transaction amount. Columns may include information about dates of the deposit and/or transaction amount.

Other details displayed in transaction history 605 may include columns 611, 613 and 615. Column 611 may display the status of a transaction. Column 611 may contain information about whether a transaction is completed or pending.

Column 613 may display the frequency of a transaction. Column 613 may display information about whether a transaction is a one-time transaction.

Column 613 may display information about whether a transaction is a recurring transaction. Recurring transactions may occur on a variable basis. Recurring transactions may occur on a preset basis. The recurring transaction may include details about the frequency of recurrence.

Column 615 may display notes about a specific transaction. The notes may include any suitable information. The notes may include information included with the gift transfer. The information may be included by the donor. The information may be included by the intermediary.

For example, in note 617, transaction 607 includes details on the allowability of use for funds. Note 617 displays the restriction that donor approval is required for all use of funds from transaction 607.

In a further example, note 621 includes details about transaction 609. Note 621 contains information about the allowability of use for funds from transaction 609.

Account 600 may include beneficiary activity 623. Activity 623 may include information on use of funds by the beneficiary. The use of funds may include payments 625. Payments 625 may include all payments made by the beneficiary from the gift account. Payments 625 may include pending requests 627 and new requests 637.

Requests 627 may display any suitable information about fund use. The transfer and/or payment of funds may not be complete. Requests 627 may include a display of information about pending requests, such as payee 629, status 631 and frequency 633.

Payee 629 may display the name of the intended payee of the pending request. Status 631 may contain information about whether a pending request has been approved. The approval may be granted by the donor. The approval may be granted by the intermediary.

Status 631 may contain information about whether a pending request is awaiting approval. The approval may be pending from the donor. The approval may be pending from the intermediary.

Frequency 633 may display any suitable information about the frequency of the payment. Frequency 633 may include one or more characteristics and/or features of the frequency column described in frequency 613.

Requests 627 may include clickable link 635. Clickable link 635 may be a clickable button and/or tab. When clickable link 635 is clicked on, more details about the pending request may be displayed. Details may include any suitable details about the transaction. Details may information from a payee. Information may include usage details.

Requests 637 may display new payment and/or transfer requests. Requests 637 may display gift transfer requests previously unknown or not seen by the Donor. Requests 637 may display gift transfer requests previously seen by the Donor, but the Donor may not have taken any action on the request.

Requests 637 may include payee 639, status 641, and frequency 645. Payee 639 may be any suitable payee. Payee 639 may include one or more characteristics and/or features of the payee column described in payee 629.

Status 641 may be display any suitable information about the status of the request 637. Frequency 645 may display any suitable information about the frequency of the payment. The frequency may a requested frequency by the beneficiary. Frequency 645 may include one or more characteristics and/or features of the frequency column described in frequency 613.

Requests 637 may include options toolbar 649. Toolbar 649 may display different actions available for the donor. The donor may be able to utilize one or more options from toolbar 649 when a new request is made.

Toolbar 649 may include approve button 651. Button 651 may allow the donor to approve new payments requests by the beneficiary. Toolbar 649 may further include reject button 653. Button 653 may allow the donor to reject new payment requests by the beneficiary.

Toolbar 649 may include ignore button 655. Button 655 may allow the donor to ignore a payment and/or transfer request by the beneficiary. The account may be configured to temporarily ignore the payment and/or transfer request. The account may be configured to permanently ignore the payment and/or transfer request. The donor may be able to review the request at a later time.

Toolbar 649 may include details button 657. Button 657 may allow the donor to ask for more details on a transaction. The donor may ask the beneficiary for more details on the requested transaction. The donor may ask the intermediary for more details on the request transaction. The donor may a payee for more details on the requested transaction.

Button 657 may be used in conjunction with one or more additional options from options 649. For example, the donor may use button 655 to ignore a request for payment approval, but may ask for more details about the requested approval.

Account 600 may include options 659. Options 659 may display clickable account options available to the donor. Options 659 may include transfer 661. Transfer 661 may allow Donor to initiate a gift transfer of funds. The transfer may be to a beneficiary. The transfer may be to a payee.

Options 659 may include approved transfers 667. Approved transfers 667 may allow the Donor to view transfers that have already been approved. When clicked, approved transfers 667 may display donor transfers to a specific beneficiary. Approved transfers 667 may display donor transfers to all beneficiaries. Approved transfers 667 may display donor transfers to a specific payee. Approved transfers 667 may display donor transfers to all payees.

Options 659 may include requests 669. Requests 669 may display pending requests for additional and/or new funds. The requests may be initiated by a beneficiary. The requests may be initiated by an intermediary. The requests may be initiated by a payee.

Options 659 may include ignored requests 671. Ignored requests 671 may display all previously ignored requests for gift transfers.

Options 659 may further include bill view 673. Bill view 673 may display to the donor all bills of the beneficiary. The bills may be uploaded by the beneficiary. The bills may be submitted by a payee. The bills may be amassed by the intermediary.

Options 659 may include send message 675 and 679. Send message 675 may allow the Donor to communicate with the beneficiary. The message may be sent to the beneficiary's account. The message may be sent to the beneficiary's e-mail account. Send message 679 may allow the donor to communicate with Bank A. Responses 681 may display to the donor all incoming messages from the beneficiary.

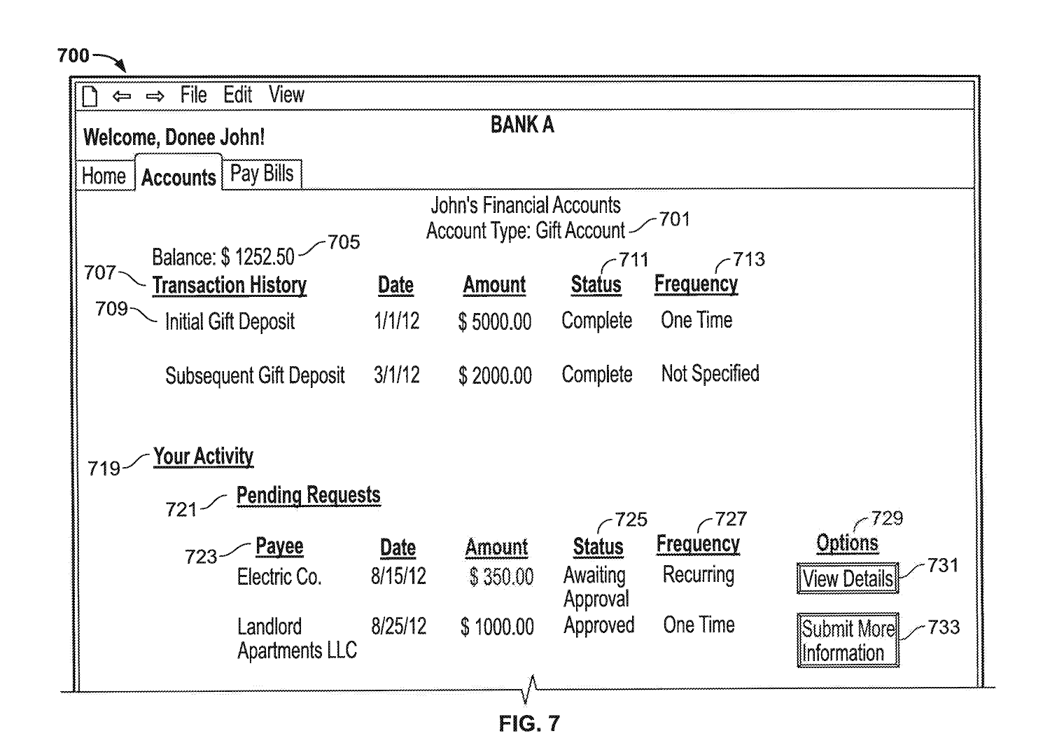

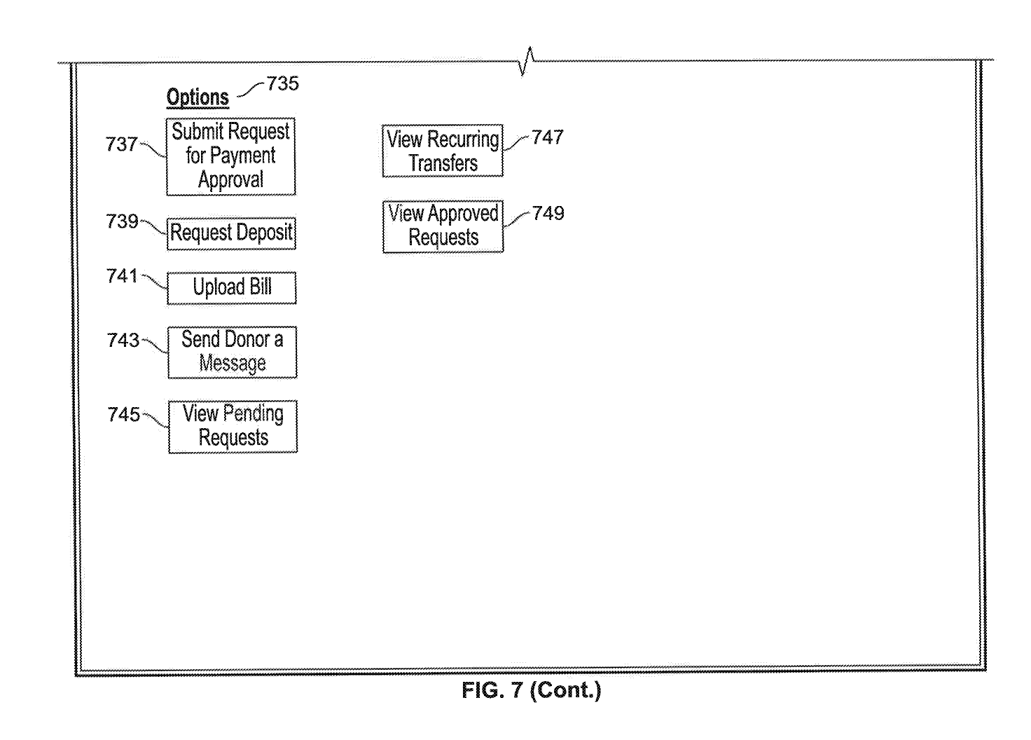

FIG. 7 shows an exemplary graphical display of Account 700 that may be generated and displayed to the donee in accordance with the systems and methods of the invention.

FIG. 7 may include heading 701. Heading 701 may include information about the type of financial account being displayed. Heading 701 may state that the account is a gift account.

Account 700 may include balance 705. Balance 705 may display the total balance in the gift account.

Account 700 may further include transaction history 707. History 707 may include all deposits made into the gift account. The deposits may be made by a donor. The deposits may be made by more than one donor. The deposits may be made by an intermediary.

History 707 may include gift deposit 709. Gift deposit 709 may be the initial gift deposit. Gift deposit 709 may be made in conjunction with opening account 700.

Transaction History 707 may include status 711. Status 711 may be a display of information about the status of a transaction. Status 711 may display whether a transaction is complete. Status 711 may display whether a transaction is pending.

History 707 may include frequency 713. Frequency 713 may display information about the frequency of a transaction. Frequency may include whether a transaction is a one-time transaction or recurring transaction. Recurring transactions may occur on a variable basis.

Account 700 may include donee activity 719. Activity 719 may include donee activity related to account 700. Activity 719 may include requests 721.

Requests 721 may display a list of payment and/or transfer requests that have not been approved and/or completed. Approval may be pending from a donor. Approval may be pending from a payee. Approval may be pending from an intermediary.

Requests 721 may include columns 723, 725, 727 and 729. Column 723 may display the name of the payee. The payee may initiate the request. The donee may initiate the request.

Column 725 may display the status of a pending request. The request may be awaiting approval. The approval may be from a payee. The approval may be from an intermediary. The approval may be from a donor. The request may be approved.

Column 727 may display the requested frequency of the pending request. The frequency may be a one-time transaction. The frequency may be a recurring transaction. The recurring transaction may be on a variable basis.

Column 729 may display options available. Options may include clickable buttons 731 and 733. Clickable button 731, when clicked, may allow the donee to view details about a pending request.

Clickable button 733, when clicked, may allow the donee to submit additional information. The additional information may be submitted to the donor. The additional information may be submitted to the intermediary. The additional information may be submitted for the purpose of approving the request.

Account 700 may include options toolbar 735. Toolbar 735 may display clickable account options available to the donee. Toolbar 735 may include button 737. Button 737 may allow the donee to submit a request for payment approval. The payment approval may be for use of current gift funds. The request may be sent to the donor. The request may be sent to an intermediary.

Toolbar 735 may include deposit request 739. Deposit request 739 may allow the donee to request additional gift funds. The request may be sent to the donor. The request may be sent to a new, potential donor. The request may be sent to an intermediary.

Toolbar 735 may include upload bill 741. Upload bill 741 may allow the donee to submit an outstanding bill. The bill may be submitted for the purpose of requesting a payment. The bill may be viewable by the intermediary. The bill may be viewable by the donor. The bill may be verified by a payee. The bill may be sent as an attachment to a new, potential donor.

Toolbar 735 may include send message 743. Send message 743 may allow the donee to communicate with the donor. The donee may request additional funds. The donee may request approval of payment transfers. The donee may respond to donor communications.

Toolbar 735 may include pending requests 745. Pending requests 745 may be configured to display requests made by the donee. The requests may include a request for additional funds. The requests may include a request for payment approval.

Toolbar 735 may include recurring transfers 747. Transfers 747 may be configured to display recurring transfers to the donee's account.

Toolbar 735 may include approved requests 749. Requests 749 may be configured to display requests for additional funds. The requests may have been approved by the donor. Requests 749 may be configured to display requests for payment approval. The requests may have been approved by the donor.

Requests 749 may be configured to display requests for additional funds. The request may have been approved by the intermediary. Requests 749 may be configured to display requests for payment approval. The requests may have been approved by the Intermediary.

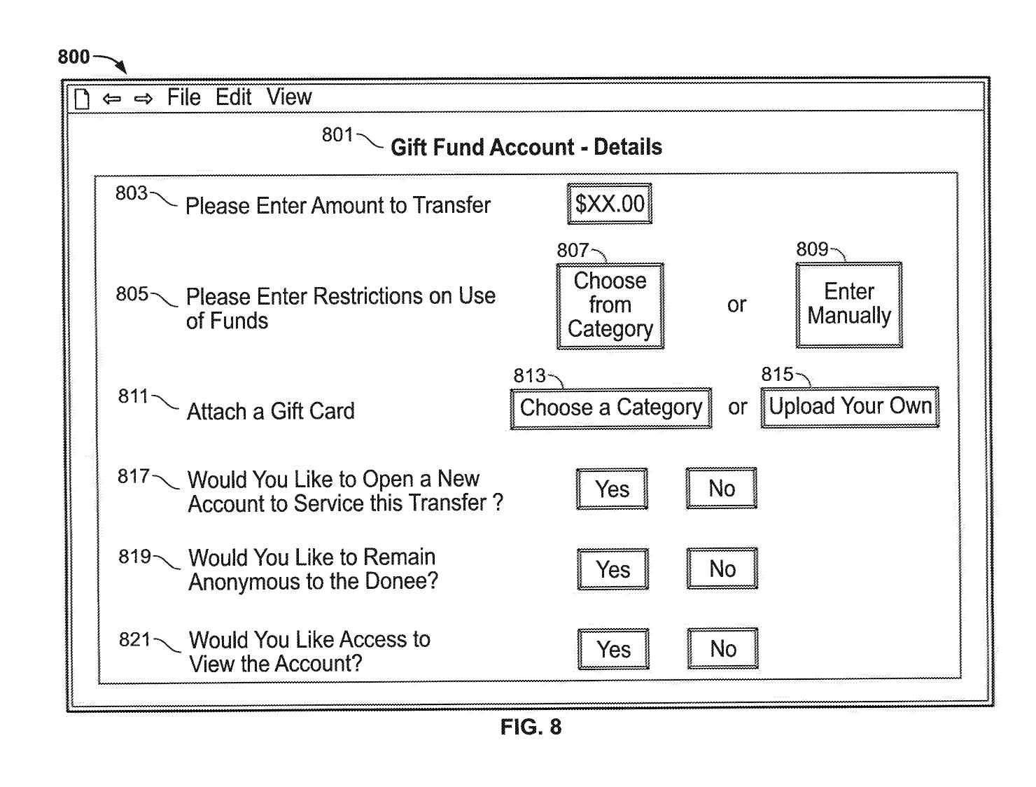

FIG. 8 shows an exemplary graphical display of Account Options 800 that may be generated and displayed to the donor in accordance with the systems and methods of the invention.

FIG. 8 may include heading 801. Heading 801 may include information about the type of financial account being displayed. Heading 801 may display that the account is a gift account.

Options 800 may include amount 803. Amount 803 may allow the donor to enter an amount to be transferred. The amount may be transferred to a beneficiary. The amount may be transferred to a payee or creditor. The amount may be transferred to an intermediary.

Options 800 may allow the donor to enter restrictions 805. Restrictions 805 may earmark the gift funds for certain uses. The uses may be predetermined. The intermediary may choose predetermined uses for the funds. The donor may choose predetermined uses for the funds. The donor may choose predetermined uses from category options 807.

Category options 807 may display common categories of earmarks. Category options 807 may display categories selected by an intermediary. The donor may choose predetermined uses for funds by entering earmarks manually in text box 809.

Options 800 may include option 811. Option 811 may allow for the donor to attach a greeting card with the transfer. Option 811 may allow the donor to send a greeting card with the transfer. The greeting card may be sent by any suitable means. The greeting card may be sent by e-mail and/or physical mail.

The greeting card may be selected from categories 813. Categories 813 may be configured to display greeting cards relevant to the type of transaction. Categories 813 may display greeting cards chosen by the intermediary.

Option 811 may include upload 815. Upload 815 may allow the donor to upload a greeting card with the gift payment. The greeting card may be a file. The greeting card may be a photograph.

Options 800 may include Option 817. Option 817 may allow a Donor to open a new financial account. The new financial account may be opened to service the gift transfer.

Option 819 may allow the Donor to remain anonymous to the donee. Option 821 may allow the donor to have access to the newly created financial account. The access may be permitted access. The access may be restricted access.

Aspects of the invention have been described in terms of illustrative embodiments thereof. A person having ordinary skill in the art will appreciate that numerous additional embodiments, modifications, and variations may exist that remain within the scope and spirit of the invention.

One of ordinary skill in the art will appreciate that the apparatus features described herein and illustrated in the FIGS. may be arranged in other than the recited configuration and that one or more of the features may be optional. Also, the methods described herein and illustrated in the FIGS. may be performed in other than the recited order and that one or more steps illustrated may be optional. The above-referenced embodiments may involve the use of other additional elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Thus, systems and methods for attaching information to an online bill payment have been provided. Persons skilled in the art will appreciate that the present invention can be practiced by other than the described embodiments, which are presented for purposes of illustration rather than of limitation, and that the present invention is limited only by the claims that follow.

What is claimed is:

1. One or more non-transitory computer-readable media storing computer-executable instructions which, when executed by a processor on a computer system perform a method of gifting funds, the method comprising:
receiving an attachment from a donor, the attachment submitted by the donor for inclusion in a gratuitous transfer of funds to a beneficiary;
tagging the transfer using an electronic marker, the tagging comprising a set of predefined parameters restricting the use of the funds;
restricting the use of the funds according to said predefined parameters;
electronically transmitting the gratuitous transfer of funds; and
confirming the transfer by an electronic notification.

2. The media of claim 1 wherein the gratuitous transfer is executed using one of:
online bill payment;
debit card transaction;
credit card transaction;
automated clearing house (“ACH”) transfer; or
paper check.

3. The media of claim 1 wherein the beneficiary is one of:
a donee;
a creditor;
a payee; or
an intermediary.

4. The media of claim 1 wherein the use of funds is restricted by donor instructions.

5. The media of claim 1 wherein the funds are accompanied by a greeting card.

6. The media of claim 1 wherein the beneficiary is prevented from using the funds.

7. The media of claim 6 wherein said prevention occurs as a consequence of an attempted unapproved use of funds by the beneficiary.

8. The media of claim 7 wherein said prevention is effected by one of:
a donor;
a creditor;
a payee; or
an intermediary.

9. The media of claim 1 wherein a new account is opened to service the transferred funds.

10. The media of claim 9 wherein the account is accessible to both the donor and the beneficiary.

11. The media of claim 10 wherein the donee requests additional funds using the account.

12. The media of claim 1 wherein the donor's identity remains anonymous to the beneficiary.

13. The media of claim 1 wherein the attachment is a branded store-value card.

14. One or more non-transitory computer-readable media storing computer-executable instructions which, when executed by a processor on a computer system perform a method of gifting funds, the method comprising:
transmitting to a donor a payment opportunity, said payment opportunity being offered to benefit a donee;
receiving an attachment from a donor, the attachment submitted by the donor for inclusion in a gratuitous transfer of funds to a beneficiary;
tagging the transfer using an electronic marker, the tagging comprising a set of predefined parameters restricting the use of the funds;
restricting the use of the funds according to said predefined parameters;
electronically transmitting the gratuitous transfer of funds; and
confirming the transfer by an electronic notification.

15. The media of claim 14 wherein the opportunity for payment is transmitted by one of:
a beneficiary;
a payee; or
an intermediary.

16. The media of claim 14 wherein the gratuitous transfer is executed using one of:
online bill payment;
debit card transaction;
credit card transaction;
ACH transfer; or
paper check.

17. An apparatus for providing a gift transfer using online billpay, the apparatus comprising:
an electronic processor module comprising a memory, a database and a network connection configured to:
receive an attachment from a donor, the attachment submitted by the donor for inclusion in a gratuitous transfer of funds to a beneficiary;
tag the transfer using an electronic marker, the tagging comprising a set of predefined parameters restricting the use of the funds;
restrict the use of funds by the beneficiary according to said predefined parameters;
an electronic transmitter configured to transmit the gratuitous transfer of funds; and
an electronic receiver configured to receive confirmation of the transfer by an electronic notification.

18. The apparatus of claim 17 wherein the gratuitous transfer is executed using one of:
online bill payment;
debit card transaction;
credit card transaction;
automated clearing house (“ACH”) transfer; or
paper check.

19. An apparatus of claim 17 wherein the apparatus is a mobile device.

20. The apparatus of claim 17 wherein the predefined parameters comprise a list of one of:
preapproved payees; or
preapproved creditors.

21. The media of claim 17 wherein the predefined parameters comprise a preapproved payment amount.

22. The media of claim 17 wherein the predefined parameters require preapproval by the payor for the use of the funds.

23. The media of claim 17 wherein the funds are transferred to an escrow account.

24. The media of claim 23 wherein the escrow account is automatically prevented from disbursing funds to one of an:
unapproved payee; or
unapproved payment amount.

25. One or more non-transitory computer-readable media storing computer-executable instructions which, when executed by a processor on a computer system perform a method of gifting funds, the method comprising:
receiving an electronic instruction from a donor to send a personalized greeting card and gratuitous transfer of funds to a beneficiary,
wherein the gratuitous transfer of funds is effected by a negotiable instrument; and
submitting, to an electronic processor, a set of instructions to:
create the greeting card;
send the greeting card;
create the negotiable instrument; and
send the negotiable instrument.

26. The media of claim 25 wherein the gratuitous transfer is executed using one of:
online bill payment;
debit card transaction;
credit card transaction;
automated clearing house (“ACH”) transfer; or
paper check.
